(19) United States
(12) Patent Application Publication
(10) Pub. No.: US 2026/0120014 A1
(43) Pub. Date: Apr. 30, 2026

(54) SYSTEM AND METHOD FOR OPERATING A SERVICE FOR HIRING ON-DEMAND LICENSED PRIVATE SECURITY BODYGUARDS

(71) Applicant: Jose Ibarra, Woodland Hills, CA (US)

(72) Inventor: Jose Ibarra, Woodland Hills, CA (US)

(21) Appl. No.: 18/932,559

(22) Filed: Oct. 30, 2024

(51) Int. Cl. G06Q 10/0631; G06Q 30/04; G06Q 50/26

(52) U.S. Cl. CPC G06Q 10/063112; G06Q 30/04; G06Q 50/265

(57) ABSTRACT

The present invention pertains to a system and method for operating a service for hiring on-demand, licensed, private, emergency security bodyguards. The system provides security options to the consumer for their safety and protection via an application. The security options include agents, namely security guards and bodyguards, that consumers can request using an application for such a purpose. The system permits agents to apply for employment and provide security services upon request to clients.

### BACKGROUND OF THE INVENTION

The present invention is directed to a system and method for operating a service for hiring on-demand, licensed, private security bodyguards. The use of ride-sharing platforms and related models of service is prominent and growing. However, security concerns on behalf of the consumer remain prevalent. Current platforms do not utilize their application for the sharing of licensed, private security for those in need of private protection. Additionally, current platforms assign ride-sharing services to consumers and do not grant consumers the ability to choose who delivers their service.

The present invention introduces the sharing of licensed, private security bodyguards in the production of an application for requesting said bodyguards. The use of this platform provides on-demand private security for customers for a plurality of reasons including and not limited to event, transportation, business, or personal security protection. The present invention provides the novel ability to provide on-demand licensed, private, emergency security for consumers that consumers may select for themselves.

### SUMMARY OF THE INVENTION

The present invention pertains to a system and method for operating a service for hiring on-demand, licensed, private, emergency security bodyguards. The system provides security options to the consumer for their safety and protection via an application. The security options include agents, namely security guards and bodyguards, that clients can request using an application for such a purpose. The choice of service and agent may be left entirely to the client. The present invention utilizes an application that allows clients to register and request a variety of security options. Clients may clarify their age, location, and payment information before requesting a security service. Clients are presented with information on the available security agents including cost, both total and per hour, background, rating, and security specialization to facilitate the client's informed, conscientious decision. After making their selections, clients may verify their information and order prior to their purchase. After their purchase, clients may both modify their selection and see the details of their booking.

The present invention provides clients with the ability to select their preferred requirements for their security booking. These requirements include and are not limited to the number of agents, whether a vehicle is desired, whether an armed agent is desired, and how long the service may last (i.e. a shift's duration or around the clock). Clients may also schedule their security in advance and where they want to be picked up and dropped off. Clients may be able to locate the details of their previous and upcoming bookings in their application.

The present invention provides on-demand private security for customers for a plurality of reasons including, and not by way of limitation, event, transportation, business, or personal security protection. Clients may utilize their application to request for security agents to accompany them to events including business, school, and other private events, to drive or travel with clients from an origin point to an end point, or for any other desired personal security reason.

In the preferred embodiment, the present invention utilizes an online application for the transportation of clients and employment of agents with computing devices. Clients with personal computing devices including, and not limited to, smartphones, mobile phones, or laptops, may utilize their device to access the application for requesting on-demand private security. Agents may use their devices to access the application to respond to security requests. Moreover, user devices may be used to direct transportation for agents to travel to clients, for example, and not by means of limitation, providing agents with directions for the optimal way to travel to and with a client through the application's map feature. Users may also use third-party map applications for travel.

The present invention may allow for real-time tracking of users through the application. Users may enable their application to access their location always or whenever they are utilizing the application. Clients may be able to view the geographic location of agents both prior to and during a booking. Clients may view important geographical information including, but not limited to, the geographic location and estimated travel time of agents while assessing which agent(s) to book to factor into their decision. Clients may also view the specific location of their booked agent(s) after a booking is made in order to know where their requested agent(s) are relative to them for one or more purposes including knowing security is on its way. Agents may also view important geographic information of clients both prior to and during a booking. Agents may be able to view the geographic location of potential clients before deciding whether to accept a service request. Agents may view the requested location of a client once a service request is accepted to allow agents to arrive at the appropriate location to provide their services. In some embodiments, when agent and client are together, the location of both may be tracked to ensure the request service is being carried out. For example, and not by means of limitation, the application may track users during a driver service to ensure client(s) and agent(s) travel from the origin point to the end point of the service appropriately and within the service parameters.

In one or more embodiments of the present invention, the system and method include, and not by means of limitation, the ability for agents to receive one or more requests for service while currently conducting a first service. The second service may accommodate and not impede the agent's carrying out of the first service. Agents may decide which service requests to accept and which to reject. Secondary service requests may consider information including, but not limited to, agent location and potential time of arrival. Secondary service requests may communicate the appropriate information to the client requesting a service which may impact the client's decision of their selected agent.

The present invention provides users with additional features to enhance their safety. In the preferred embodiment, users may engage in a live chat with customer service to receive help with their booking. For example, and not by means of limitation, if the received bodyguard is not the same as the requested bodyguard, clients may communicate directly with a customer service representative to amend the issue. Moreover, any security guard that can be requested will be licensed, insured, and thoroughly vetted to ensure the safety of the consumer.

The present invention also utilizes two-factor security authentication for the safety of its users. Both agents and clients may be required to input a unique code to access their account on the application. This code may be sent to the user's phone number after they enter their email and password login credentials. The user may give the application its phone number during the sign-up process. The two-factor security authentication serves to guarantee that unauthorized users will not have access to the application.

The present invention utilizes an application that also allows agents to register as security bodyguards to provide security to clients. Agents may provide their phone number, address, date of birth, languages spoken, years of experience, and offered services to their profile. Agents may also upload their photo, driver's license, guard card, medical information, vehicle registration, weapon license, background check, and additional security documents. Once their information is submitted, their application is reviewed, and the agent is either denied or granted access to the application to serve as a security agent. Once accepted, agents may upload their payment details, bank details, and W-9 or W-2 form for employment and tax purposes. Agents may view service requests in their area, select which requests to respond do, and confirm their booking.

In one or more embodiments, the present invention may utilize a system and method for the transportation of clients by agents with weapons and the appropriate weapon licenses. When requesting on-demand personal security, clients may prefer agents to have licensed weapons for increased client security. Clients may clarify this preference before booking a security service. Agents may carry and utilize their licensed weapon during the service as necessary or as requested. The client may be notified of the specific weapon's license and registration.

The present invention may use notifications to alert both clients and agents of necessary and helpful application and booking details. When a user joins the application, they may turn permissions for receipt of notifications on or off. When notifications are on, the user may receive notifications pertaining to previous, current, or upcoming booking(s) even when they are not using the application on their computing device. These notifications may alert users of important booking details including and not by way of limitation arrival time, messages from their agent(s) or client(s), safety responses, and application requests for user rating and feedback or agent tip. Notifications may also alert agents to clients in need of immediate and emergency assistance. Notifications may also alert agents to their online or offline status. When notifications are off, the user may only receive alerts when they are actively using the application on their computing device. Security agents may clarify whether they are available by editing their status in their application to online or offline which may impact notification deliverance. For example, and not by means of limitation, in the event that the agent cancels the booking, the client may be notified and provided new agent options from which to select. In the event that the client cancels the booking, the agent may be notified and provided new client options from which to select. The notification process may include, and not by means of limitation, a pop-up notification within the application when the user has it open, a pop-up notification on a user's home screen and lockscreen when the user has the application closed, emails to the user, and texts to the user.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1A shows the initial set-up and login process for new clients of the application.

FIG. 1B shows the login process for existing users of the application.

FIG. 2A is a diagram outlining the client's use of the application when requesting a security service.

FIG. 2B is a diagram outlining the booking process on the application when a client is requesting a specific security service.

FIG. 2C is a diagram outlining the perspective of the client when opening their application before requesting a service.

FIG. 3 is a diagram outlining the use of the present invention in the case of requesting personal security for transportation purposes.

FIG. 4 is a diagram outlining the web services incorporated with server-client communication.

FIG. 5 is a diagram of the flow of access between the platform of the present invention and the web services client via cloud software tools.

FIG. 6A illustrates the login screen for users for the preferred embodiment of the invention.

FIG. 6B illustrates the verification screen for users to more securely log into their account in the preferred embodiment of the invention.

FIG. 6C illustrates the sign in screen for users when they first join the security application.

FIG. 6D illustrates the registration page of the application whereby users may input their name, email, and password in order to register to utilize the service.

FIG. 6E illustrates the homepage of the application for a client.

FIG. 6F illustrates the preferred embodiment of the service details screen where the client may determine their requirements for their desired booking.

FIG. 6G illustrates the search results screen of a client's booking. It may show the available agents, and in addition, agents'price per hour, ranking, photo, specialization, and location.

FIG. 6H illustrates the selected agent's details before the client books the agent.

FIG. 6I illustrates the screen that shows the client the estimated time of arrival of their booked agent(s).

FIG. 6J illustrates the Activity screen of the application demonstrating a client's current and previous bookings.

FIG. 6K illustrates the completed booking screen that a client sees on their application once their booked service is complete.

FIG. 6L illustrates the receipt screen a client may see after their completed service.

FIG. 6M illustrates an example of a profile for a registered security agent on the application.

FIG. 7A illustrates information that may be required of agents when registering in the application.

FIG. 7B illustrates forms of identification that may be required of agents to provide when registering in the application.

FIG. 7C illustrates the application asking agents for their medical information that may be required.

FIG. 7D illustrates the application asking agents to upload their weapon license information that may be required.

FIG. 7E illustrates the background check screen that may be required for an agent to successfully join the application.

FIG. 7F illustrates the documents that may be required of agents to submit to the application for employment.

FIG. 7G illustrates the confirmation page for agents once they have submitted all documents required of them to apply for employment with the application.

FIG. 7H illustrates the homepage of the application from an agent's perspective.

FIG. 7I illustrates what a potential client booking may look like from an agent's perspective both before and after booking.

FIG. 7J illustrates an agent's screen on the application after a service is completed.

FIG. 7K illustrates an agent's receipt screen on the application after a service is completed.

FIG. 7L illustrates an agent's application when entering their bank details for payment.

FIG. 8A is a flowchart of the account creation and registration process for a security agent on the application.

FIG. 8B is a flowchart of the document upload and agent process to request to register as an employee on the application.

FIG. 9 is a flowchart demonstrating the background check process for applying agents seeking employment via the application.

FIG. 10 is a flowchart demonstrating the booking process from the perspective of an agent via the application.

FIG. 11 illustrates a sample notification a user may receive within their application.

FIG. 12 illustrates the communication between several components of the present invention.

FIG. 13A illustrates, in some embodiments, the receipt of a request for an agent while the agent is currently conducting another service request.

FIG. 13B demonstrates an example of an agent receiving a second driver service request while conducting a first driver service request.

FIG. 14A is a diagram showing the application using the location of a user's computing device to track user location and ensure service production and completion.

FIG. 14B is a diagram demonstrating one embodiment of the present invention in which an agent may, after receiving and accepting a request for service, travels with their mobile computing device to the location of the client with their mobile computing device.

FIG. 14C is a flowchart showing the process of the location data of a user's mobile computing device being sent to the network for transmission to other computing devices.

FIG. 15 illustrates one or more embodiments of the use of the application by client and agent to secure security services.

FIG. 16 is a diagram illustrating one embodiment of a security coordination system for client and agent.

FIG. 17A is a block diagram illustrating a potential embodiment of the security coordination system.

FIG. 17B is a drawing demonstrating one embodiment of user feedback being used to impact safety and communication on the application.

FIG. 17C provides an exemplary notification progression a user may receive based on user feedback and analysis from the machine learning engine.

FIG. 18 is a flowchart demonstrating one embodiment of a method for preemptively navigating agents to clients at an event initially without an end time.

FIG. 19 illustrates a potential embodiment of a system response to an agent not following the mapping directions for a client's requested security service.

FIG. 20A demonstrates a map with the system-provided route and the alternative route an agent takes instead and how the course is corrected in one embodiment.

FIG. 20B is a flowchart demonstrating a potential embodiment of the system's map system and route selection process.

FIG. 21A illustrates one embodiment of the system application's arrival point selection process.

FIG. 21B illustrates one embodiment of the system application's arrival and departure point selection process for security driver services.

FIG. 22A is a map diagram with potential arrival points for an agent to be directed to during a security booking.

FIG. 22B is a map diagram with potential departure points for an agent to be directed to during a driver security booking.

FIG. 23 illustrates one embodiment of a process for clients editing booking details and agents being notified.

### DETAILED DESCRIPTION OF THE PREFERRED EMBODIMENT

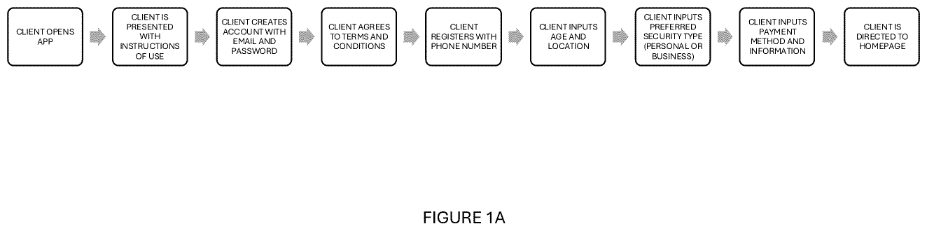

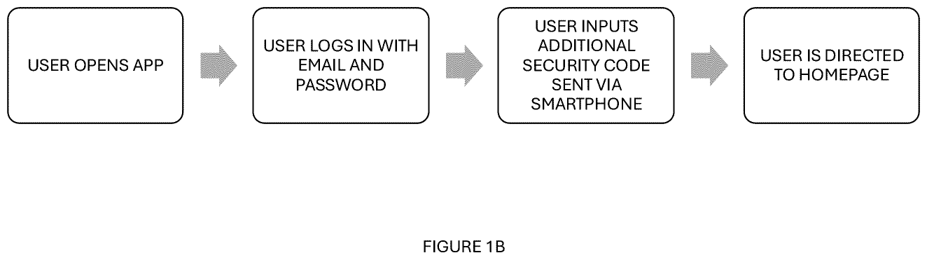

FIG. 1A is a diagram demonstrating the setup and login process for new clients of the security application. The client opens the application and is presented with a welcome message that explains the function of the application and its services. The client is then prompted to create an account with their name, email, and selected password, and the client may accept the application's Terms & Conditions. The client may then be prompted to enter their phone number, date of birth, and location for further safety measures. The client may select their preferred security service of either personal protection or business protection. The client then enters their preferred payment method and payment information for future facilitation of the booking process. In the final step, the client is brought to their application homepage.

FIG. 1B is a diagram outlining the login process for existing users of the security application. The user opens the application and inputs their already created email and password. The user is sent an additional unique security code to their phone number to verify their identity. In the final step, the user is brought to their application homepage.

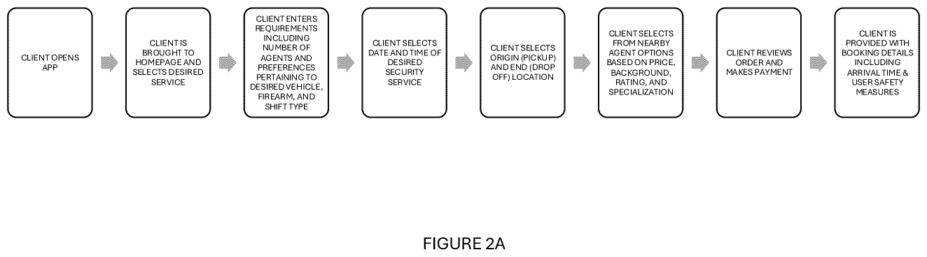

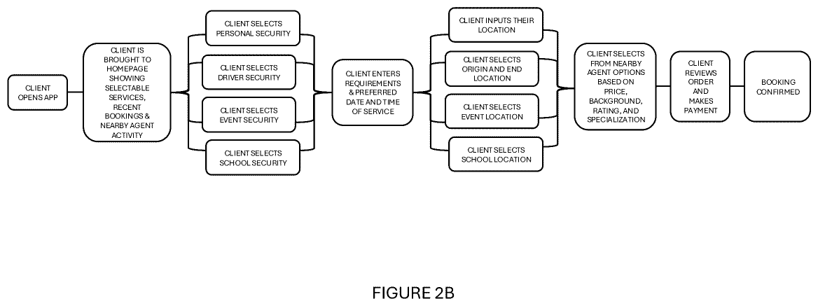

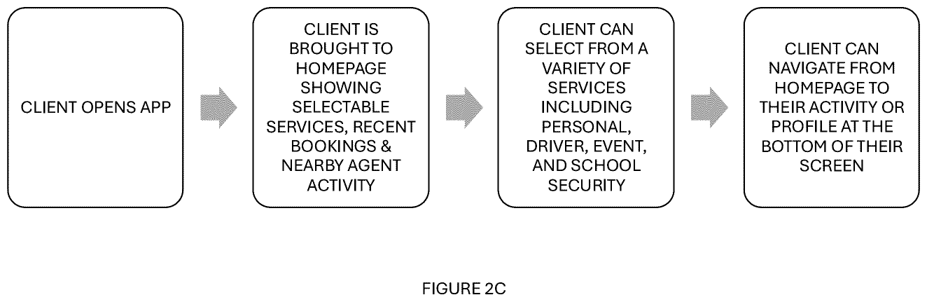

FIG. 2A is a diagram providing the steps of use of the application when a client is requesting a security service. The client opens the app and is brought to their homepage as delineated in FIGS. 1A and 1B. On their homepage, the client may select their desired service including security agents for personal, driver, event, and school security. Once a selection is made, the client enters their desired requirements for their security service. The available requirements include the number of agents desired. The client may also make selections on vehicle preferences including whether a vehicle is desired and the desired type of vehicle. The client may also select whether they want their agent(s) to be armed. The client may also select the desired shift type for their agent(s) including an hourly shift or a round-the-clock option. After these requirements are communicated, the client selects the desired date and time for their security service. The client then selects their desired origin (pickup) location and end (drop off) location for themselves and their agent. Based on these restrictions, the client selects from the provided map of nearby agents. Information including price per hour, agent background, agent rating, and agent specialization are provided to the client to factor into their decision. Once the client makes a selection, the client may review their order and make their payment with their saved payment information. The client is then provided with their booking details including arrival time and agent information. The client is also shown user safety measures including the ability to report issues and engage with the application's live chat function.

FIG. 2B demonstrates the booking process on the application when requesting a specific security service. After the client opens their application, they are brought to their homepage where they may be presented with selectable services, recent bookings, and nearby agent activity. The client may select personal security, driver security, event security, or school security. The client enters the requirements pertaining to number of agents, vehicle, firearm, and shift type. Based on the security service selected, the client may input their location, their desired origin and end location, event location, or school location. The client selects from nearby agent options based on factors including and not by way of limitation price, background, rating, and specialization. The client reviews their order and makes their payment. The booking is confirmed.

FIG. 2C is a diagram demonstrating the perspective of the client upon opening their application for requesting a security service. After the client opens the app, the client is brought to their homepage. The top of their homepage shows a range of selectable services including security agents for personal, driver, event, and school security. The middle of their homepage shows the client's recent booking(s) if applicable. The client may scroll down their homepage to see available security agents nearby. The bottom of their homepage allows the client to navigate from their homepage to their activity or their profile.

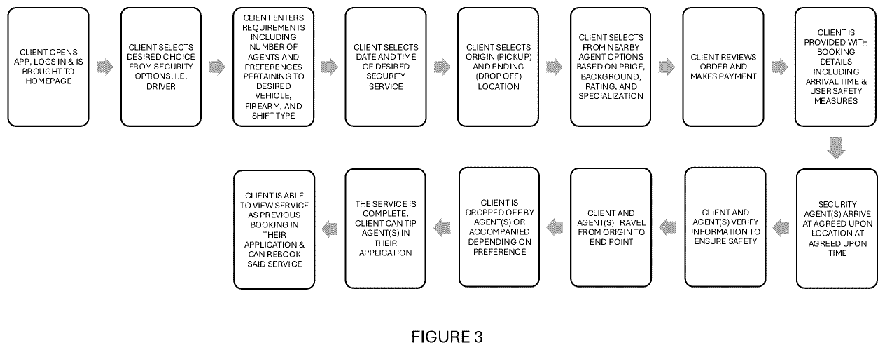

FIG. 3 is a diagram demonstrating the process of requesting and utilizing security agents from the perspective of the client, specifically for transportation/driver purposes. The client completes the log in process after opening their app and is brought to their homepage to start a booking. The client selects their desired choice of booking, in this case a security driver. The client completes their desired booking requirements including the desired number of agents. The client may also select vehicle preferences, firearm preferences, and shift type preferences as laid out in FIG. 2A. The client selects their desired date and time for their security driver. The client selects their desired origin and end location for the security driver service. The client selects from nearby agent options based on factors including price, rating, background, and specialization of the agents. The client reviews their order and makes the required payment. The client is provided with booking details including arrival time of their driver. The client is also provided with safety measures. The security agent(s) then arrived at the agree upon location at the agreed upon time. The client and agent(s) verify each other's information to ensure identity and safety of both parties. The client and agent(s) travel from origin to end point. Depending on client preferences, the client is either dropped off at their location or accompanied. Once the service is complete, the client may tip their agent(s) in their application and rate their agent(s) and service. The client may view the completed service and booking in their application and may rebook said service.

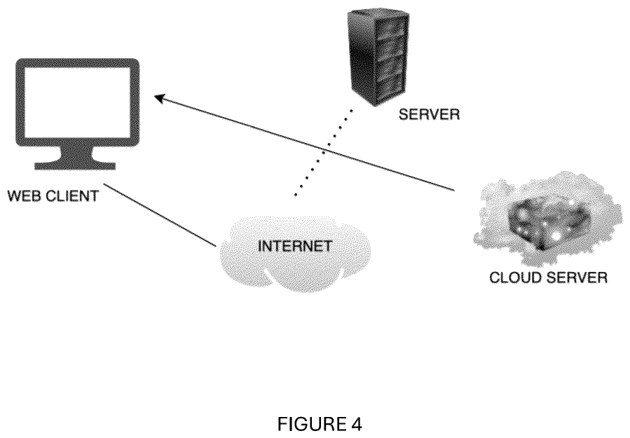

FIG. 4 is a diagram outlining the role of web services in the present invention. In accordance with the preferred embodiment, a web client interacts with the server ecosystem by way of a service connection, such as the internet, which then distributes data and pertinent information such as the web service platform to the cloud server and preliminary servers. This allows for data to be streamlined between the client and the server as well as cloud servers and other database systems. Communication between web services may be completed via Simple Object Access Protocol (SOAP) which allows multiple web service applications to communicate rapidly and efficiently and to provide data to the web client.

The infrastructure of the present invention also allows for the use of web services that enable interaction with and storage of data across devices. Specifically, these web services can allow for the use of cloud software tools and cloud-based data storage. Cloud software tools can be used to allow for increased user authentication and authorization checkpoints for data accessed between parties. The web service software aids in the transmission of data between entities while still maintaining secure access restrictions preventing any unauthorized access to the cloud data.

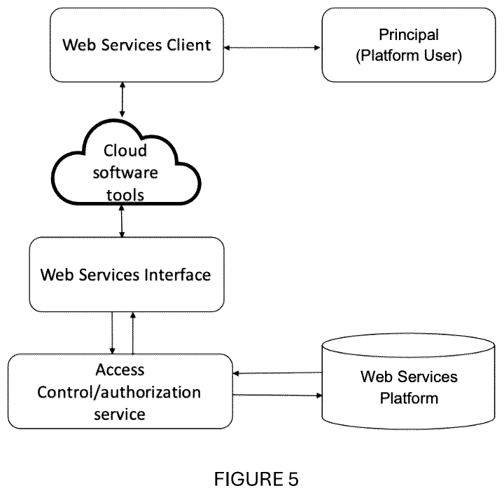

FIG. 5 is a diagram of the flow of access between the platform of the present invention and the web services client via cloud software tools. The principal or platform user accesses the web services client, which then transmits data via cloud software tools to the web services interface. Access control and authorization acts as a layer in order to access the web services platform by way of the web services interface.

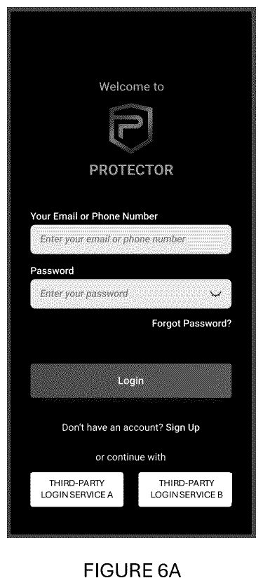

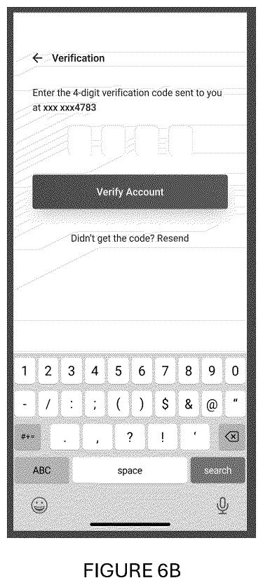

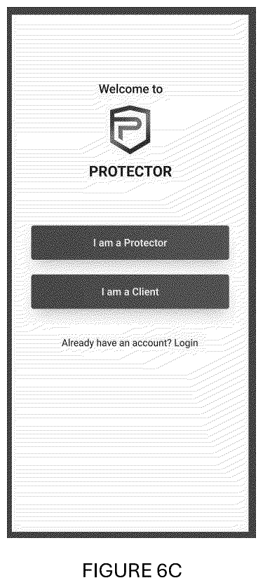

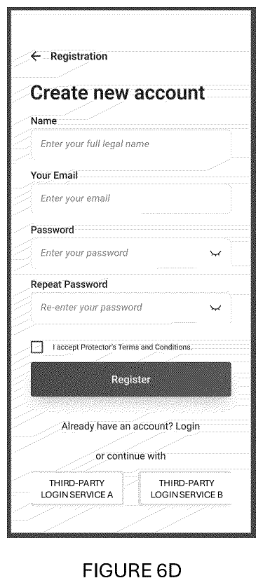

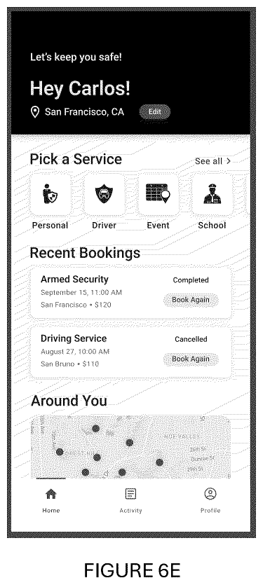

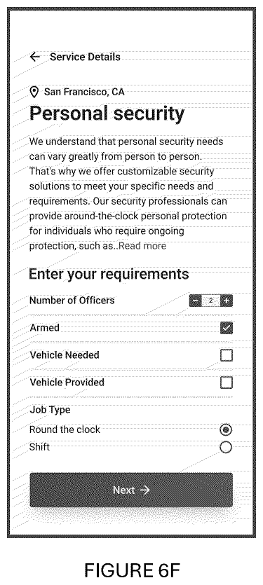

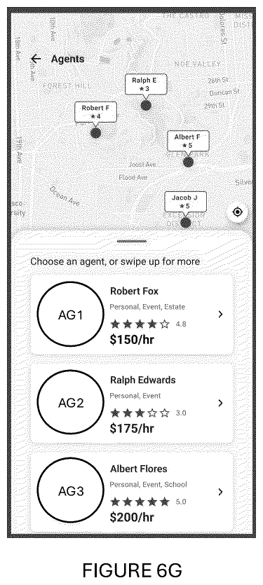

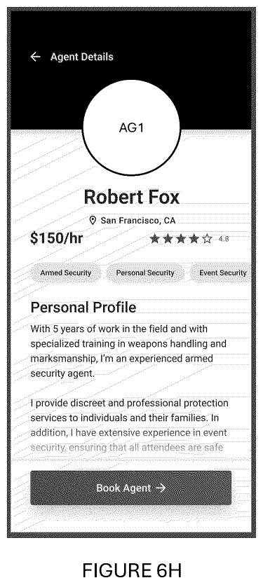

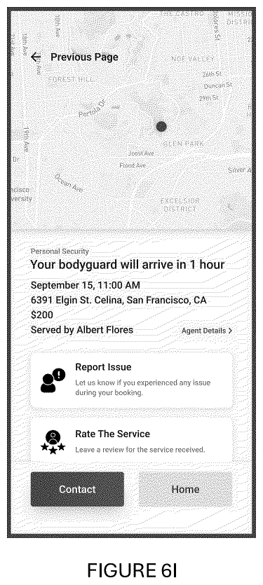

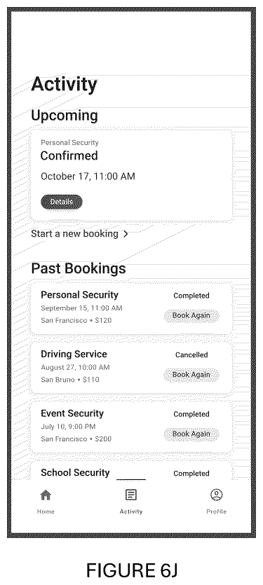

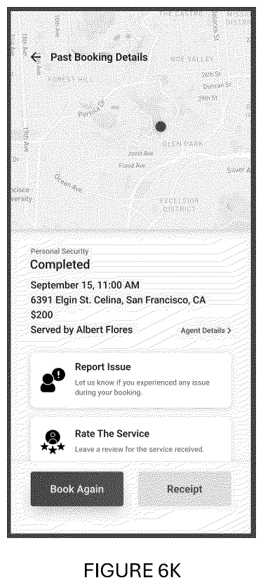

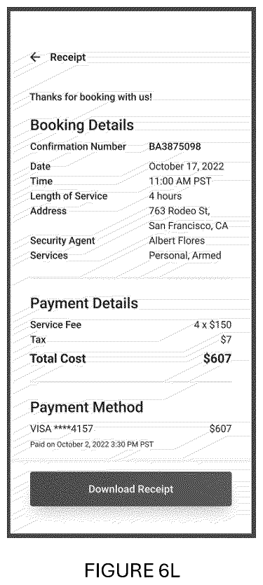

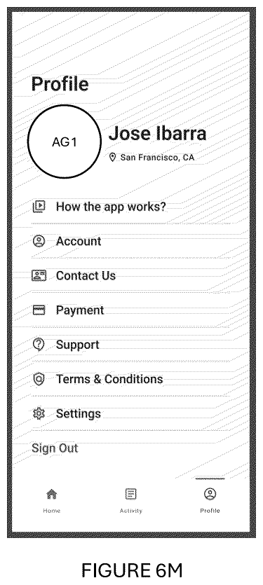

FIG. 6A shows the login screen for users for the preferred embodiment of the invention. At this stage, users enter their email and password to log into their account and either book security agents or clients.

FIG. 6B shows the verification screen for users to more securely log into their account in the preferred embodiment of the invention. Users may receive a unique code via their phone number and enter it where prompted to log into their account. The preferred embodiment may differ in visualization based on the user's computing device.

FIG. 6C shows the sign in screen for users when they first join the security application. Users may choose whether they are a security agent (a “Protector”) or a client desiring a security agent service (a “Client”). If users have already registered, they may navigate to the Login link and screen instead.

FIG. 6D shows the registration page of the application whereby users may input their name, email, and password in order to register to utilize the service. Users may also sign in with a third-party service. Users may agree to the Terms & Conditions prior to registration. If users have already registered, they may navigate to the Login link and screen instead.

FIG. 6E shows the homepage of the application for a client. The name of the client and their inputted location may be shown. The client may select their desired service, view their recent bookings, and see security agents nearby. The client may navigate to their previous activity within the app or their profile.

FIG. 6F shows the preferred embodiment of the service details screen where the client may determine their requirements for their desired booking. Based on the type of service selected by the client, the service details screen may look different. Clients may select the number of agents they desire, whether they desire a vehicle and which type, the job schedule they prefer, and whether they desire their agent(s) to be armed.

FIG. 6G shows the search results screen of a client's booking. It may show the available agents, and in addition, agents'price per hour, ranking, photo, specialization, and location.

FIG. 6H shows the selected agent's details before the client books the agent. These details may include the agent's name, photo, background, location, price per hour, rating, and specialization. The client may review the agent's details on this screen before deciding whether to book a specific agent.

FIG. 6I shows the screen that shows the client the estimated time of arrival of their booked agent(s). The details of the booking as specified by the client, including and not by way of limitation, name, date, time, address, and price, may also be seen on the screen. The client may report any issues or rate their booked service on the same screen. The client may contact their booked agent(s) or return to their homepage.

FIG. 6J shows the Activity screen of the application demonstrating a client's current and previous bookings. The client may see any upcoming and confirmed appointments. The client may edit their booking by selecting the Details button. The client may Start a new booking.

FIG. 6K shows the completed booking screen that a client sees on their application once their booked service is complete. The details of the booking as specified by the client, including and not by way of limitation, name, date, time, address, and price, may also be seen on the screen. The client may report any issues or rate their booked service on the same screen. The client may book the same agent(s) again or view their receipt.

FIG. 6L shows the receipt screen a client may see after their completed service. The details a client sees may include and not by way of limitation, their booking's confirmation number, date, time, length of service, address, security agent(s), service(s), payment details, payment total, and payment method. The client may see when they completed their purchase and may download their receipt.

FIG. 6M shows an example of a profile for a registered security agent on the application. The agent's profile may include and not by way of limitation, account, payment, and contact information about the agent.

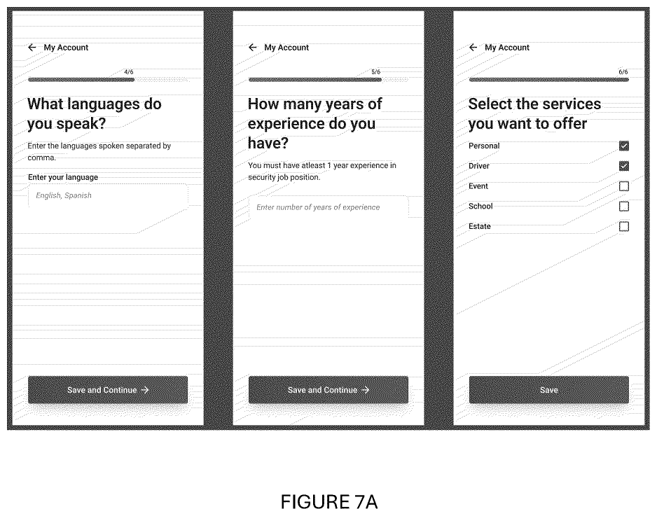

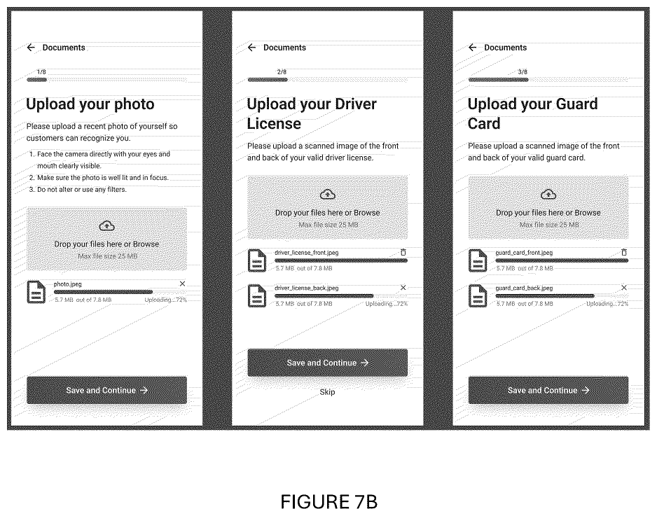

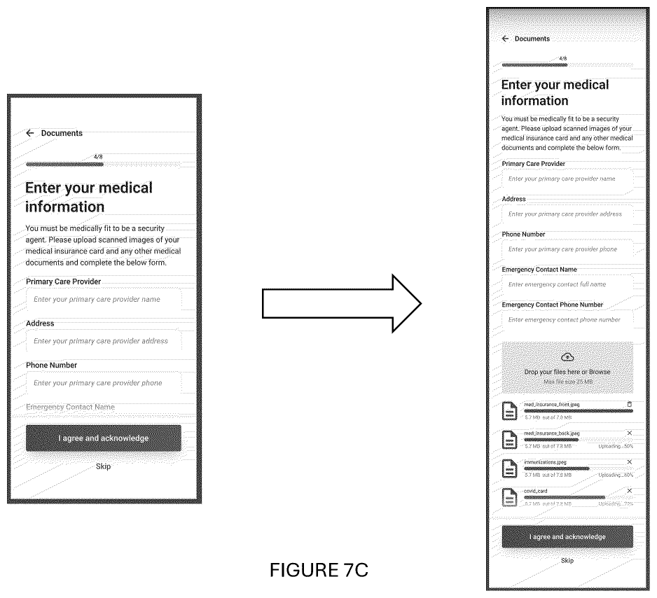

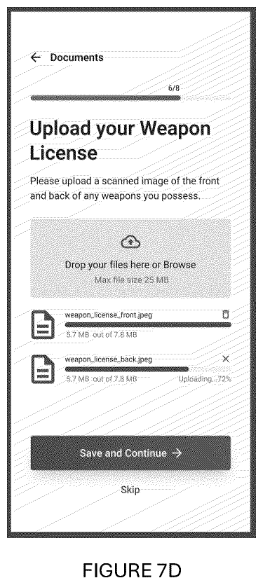

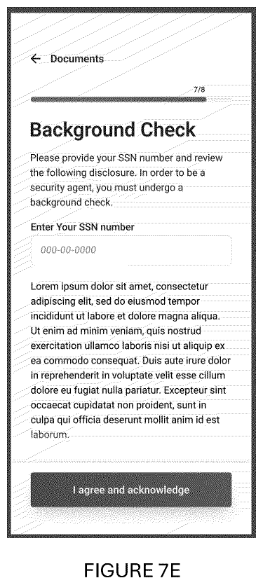

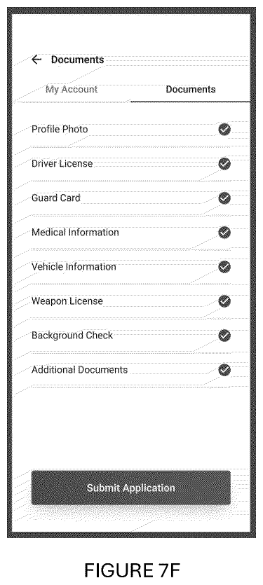

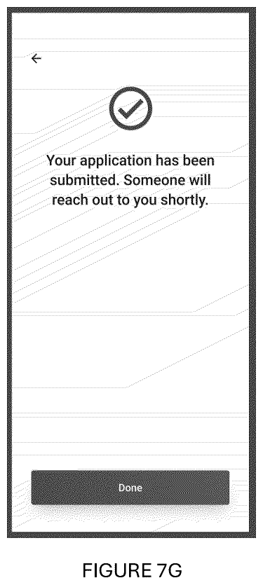

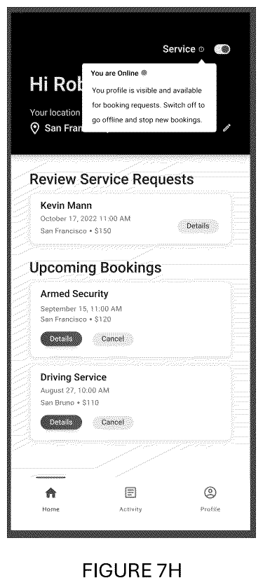

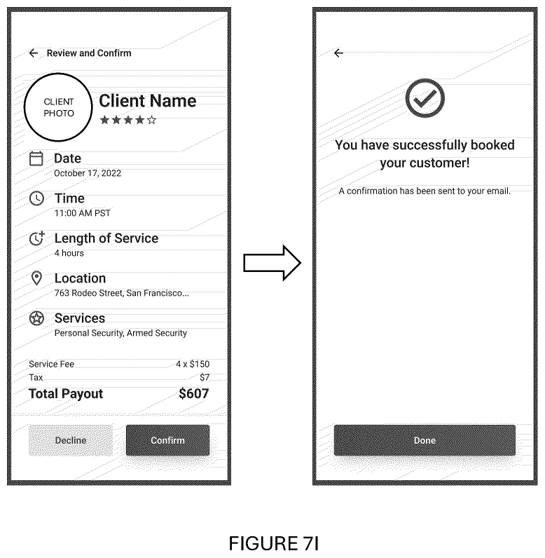

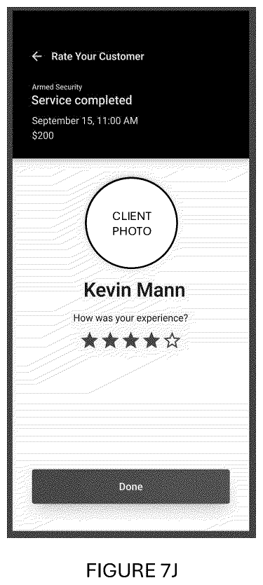

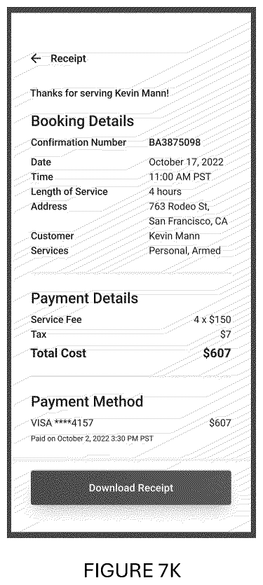

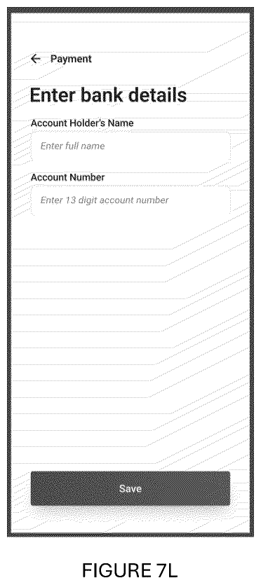

FIG. 7A shows information that may be required of agents when registering in the application. Agents may include all languages they speak or are proficient in. Agents may include the number of years of experience they have which may be more than one year of experience. Agents may select the types of services they would like to provide to clients, including and not by way of limitation personal, driver, event, and school security.

FIG. 7B shows forms of identification that may be required of agents to provide when registering in the application. Agents may upload a clear, recent, recognizable photo for clients to view and confirm their identity. Agents may upload their unexpired driver's license for identification purposes as well as confirmation they are able to drive and control a vehicle. Agents may also upload their guard card for identification purposes as well as confirmation they are able and approved to work as a security bodyguard.

FIG. 7C shows the application asking agents for their medical information that may be required. Agents may enter the information of their primary care provider, then may scroll to upload the medical documents that may be required. For example, and not by means of limitation, agents may upload their medical insurance card (both front and back), COVID-19 vaccination card, and immunizations record.

FIG. 7D shows the application asking agents to upload their weapon license information that may be required. Agents may be required to submit photos to the application of a license for each of their weapons (e.g. firearms) that may be utilized during their service.

FIG. 7E shows background check screen that may be required for an agent to successfully join the application. Agents are required to submit their Social Security Number (SSN) to undergo a background check prior to working as an agent through the application.

FIG. 7F shows the documents that may be required of agents to submit to the application for employment. These documents may include profile photo, driver's license, guard card, medical information, vehicle information, weapon license, background check, and other additional documents. These documents may be provided for the increased safety of clients and of the application as they can ensure agents are who they claim to be and have the necessary documents for employment.

FIG. 7G shows the confirmation page for agents once they have submitted all documents required of them to apply for employment with the application. Agents may wait for a response from the application's team after they are thoroughly vetted. Agents may be informed of whether they are accepted or rejected from employment with the application.

FIG. 7H shows the homepage of the application from an agent's perspective. The agent may see service requests available for their review and upcoming bookings. Agents may also indicate their availability to clients by toggling on and off their profile's visibility. If agents are online, they can receive new booking requests. If agents are offline, they cannot receive new booking requests. Agents may determine their desired online and offline status.

FIG. 7I shows what a potential client booking may look like from an agent's perspective both before and after booking. The agent may review the details of the requested client booking including, and not by way of limitation, the client's name and photo, the desired date and time of the booking, the length of service, the location, and the desired service(s). The agent may also review how much they are being paid based on their previously determined hourly rate. If the agent chooses to confirm the booking, the agent may be taken to a confirmation screen that may inform them their confirmation has been sent to their email.

FIG. 7J shows an agent's screen on the application after a service is completed. The agent may see their client's information and be asked to rate their experience working for their client out of five stars. The rating system allows other users to view ratings of both agents and clients to factor into their future booking decisions. The overall rating may be calculated from the ratings left by other users to a specific user and shown on said that specific user's profile.

FIG. 7K shows an agent's receipt screen on the application after a service is completed. The agent may view the details of the service, including and not by way of limitation the booking's confirmation number, date, time, length of service, customer, service(s) provided, payment details and information, time of payment, and total payment. The agent may download the receipt for their own records.

FIG. 7L shows an agent's application when entering their bank details for payment. Agents may input their account holder's name and account number. This payment system may facilitate payment between agent and client. Upon booking of a service, a user may be charged an initial deposit, which may be a portion of the total fee to be paid for the service, or a user may be charged the total fee upon booking. Alternatively, a user will not be charged for the service until the service has been completed. A facilitation fee and other fees may be collected from the user's payment. An agent who performs a security service will receive payment upon completion of the security service. If a planned service is cancelled by a user prior to a specified period of time, the user may not be charged for the service and the agent may not receive payment. Alternatively, if a user fails to cancel a service prior to the specified period of time, the user may be charged a late cancellation fee, a portion of which may be paid to the agent who was booked for the cancelled service. If any issues arise wherein a user or an agent believes that the agreed upon payment no longer applies, a dispute can be filed and reviewed to determine the best remedy. In order to send and receive payments, user and an agent may connect their bank information to the system by way of routing number and/or account number. The present invention may utilize direct deposit or third-party banking engines to facilitate the transfer of funds. Promotional discounts and referral programs may be used to provide discounts to users and agents who meet certain requirements.

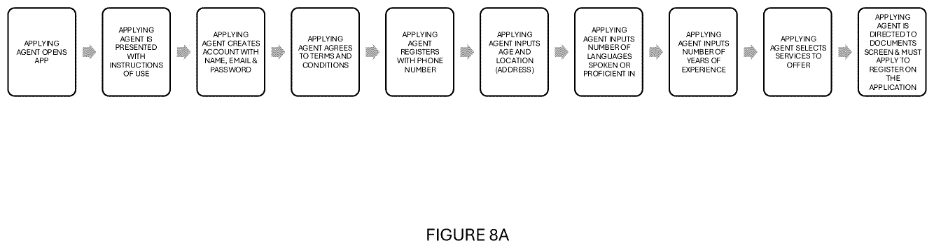

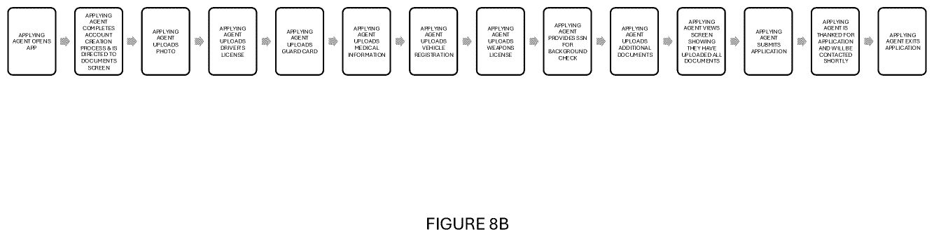

FIG. 8A demonstrates the account creation and registration process for an applying security agent on the application. The applying agent opens the application and may be presented with the application's instructions of use. The applying agent may create their account with their name, email and password. The applying agent may agree to the terms and conditions of use of the application. The applying agent may input their phone number to register for reasons including, and not by way of limitation, increased safety of the application, to send notifications, and to utilize in communication between agent and client and agent and customer service. The applying agent may input their age and location including their address for the included, and not by way of limitation, purpose of identifying their service area. The applying agent may input the number of languages they speak or are proficient in for the included, and not by way of limitation, purpose of communicating with clients. The applying agent may input the number of years of experience they have in providing security services including, and not by way of limitation, service as a bodyguard, agent, police officer, security guard, bouncer, loss prevention agent or officer, security patrol officer, executive protection agent, secret service, and security professional. The applying agent may select the security services they wish to offer to clients including, and not by way of limitation, personal, driver, event, school, and estate. The applying agent may then be directed to a documents screen on their application for upload and request to register as an employee on the application.

FIG. 8B demonstrates the document upload and applying agent process to request to register as an employee on the application. The applying agent may open their application and complete the account creation process as directed in FIG. 8A. The applying agent may be directed to a documents screen including, and not by way of limitation, upload pages for their profile photo, driver's license, guard card, medical information, vehicle information, weapon license, background check, and additional documents. The applying agent may follow the document requests by uploading their profile photo which must be a clear, recent, and recognizable photo. The applying agent may then upload their unexpired driver's license. The applying agent may then upload their unexpired guard card. The applying agent may then upload their medical information including, and not by limitation, their primary care provider's information, medical insurance card (both front and back), COVID-19 vaccination card, and immunizations record. The applying agent may then upload their vehicle registration. The applying agent may then upload their weapons license(s). The applying agent may then provide their Social Security Number (SSN) for a background check. The applying agent may then upload any other additional documents they desire for their employment request. All these records may ensure to both the application owner and clients that their security agents are well qualified for security employment. The applying agent may view a screen showing they have uploaded all documents and may proceed to submitting their employment request. The applying agent may be thanked for their application and told they will be contacted shortly with a response via email or phone number. The applying agent may then exit their application.

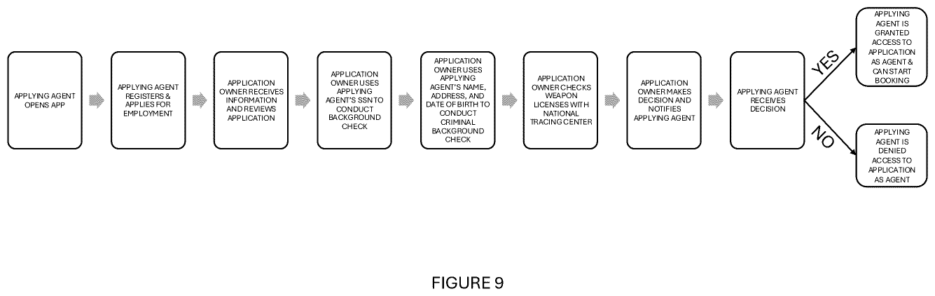

FIG. 9 demonstrates the background check process for both applying agent and application owner. The agent may open their application, register, and apply for employment as seen in FIGS. 8A and 8B. The application owner may receive the agent's information and review their application. The application owner may use the agent's SSN to conduct a background check. The application owner may also use the applying agent's name, address, and date of birth to conduct a criminal background check. The application owner may check the agent's weapon license with National Tracing Center (NTC). Background checks and the weapon license check may be run to ensure the safety of clients on the application. The application owner may then make a decision and notify the applying agent by provided email or phone number. The applying agent may receive their decision by provided email or phone number. If the applying agent receives a YES, the applying agent may be granted access to the application as an agent and may start booking clients. If the applying agent receives a NO, the applying agent is denied access to the application as an agent.

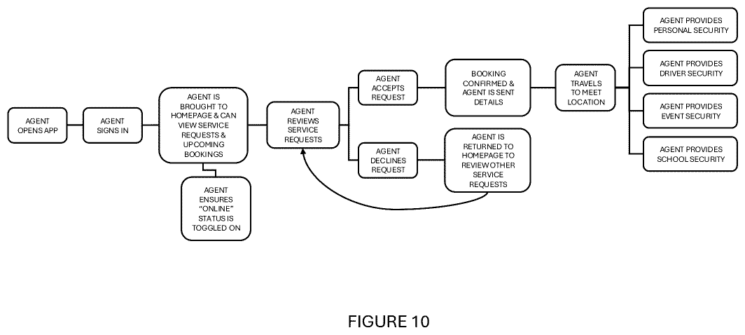

FIG. 10 shows the booking process from the perspective of an agent via the application. The agent opens the app and signs into their account. The agent may be brought to their homepage where they may review their service requests and upcoming bookings. The agent may also ensure their “online” status is toggled on in order to receive new bookings. The agent then reviews their service requests. If the agent chooses to accept a request, the booking may be confirmed and the agent may be sent the details of the booking both in their app and to their email. The agent may then travel to the location of the booking and perform their requested service. For example, and not by means of limitation, the agent may provide personal, driver, event, or school security. If the agent chooses not to accept a request, the agent may be returned to their homepage to review other service requests or view upcoming bookings.

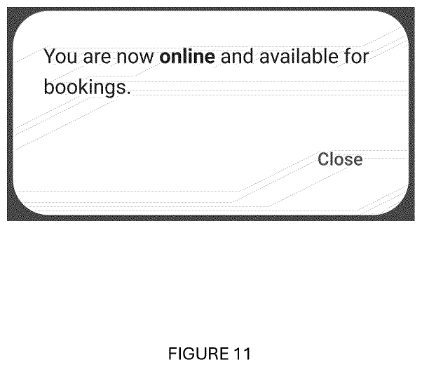

FIG. 11 shows a sample notification a user may receive within their application. For example, and not by means of limitation, the pictured notification may alert an agent that they are online and available for booking new clients. The notification may pop-up in the user's application when the user has their notification open to alert them of necessary and helpful booking and application details.

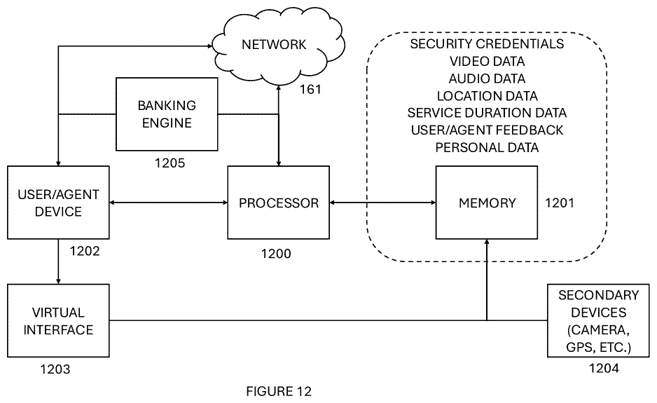

FIG. 12 illustrates the communication between several components of the present invention. In accordance with the preferred embodiment of the present invention, at least one processor 1200 is in communication with a network 161, a non-transitory computer-readable memory 1201, a user and/or agent device 1202. User/agent device 1202 hosts a virtual interface 1203 which is further in communication with a plurality of secondary devices accordingly. Virtual interface 1203 and secondary devices are also in communication with said memory 1201. A user or agent device may be, for example, and not by way of limitation, a mobile device or other computing device capable of connecting to a network 161 and communicating with a processor 1200.

The memory 1201 may store computer-executable instructions causing the system to perform a plurality of tasks. The memory 1201 may also store data and history relating to a plurality of security credentials relating to at least one agent, for example, and not by way of limitation, weapon carrying permits, driving credentials, safety and security certifications including but not limited to security training credentials, CPR (cardiopulmonary resuscitation) certifications, NREMT (national registry emergency medical technician) certifications, latest background check report as well as prior security experience. Other data collected and stored in memory 1201 may include video and audio data recorded during active security services, location data, feedback provided to and from a user or agent, respectively, and personal data including, but not limited to, height, weight, gender, name, fingerprints, other physical characteristics, contact information including phone number, email, home and/or mailing address, financial information regarding credit information, methods of payment, and other relevant information.

Secondary devices 1204 may be used to collect data during security services. Secondary devices may include, but are not limited to, body camera or other video recording devices such as dashboard cameras, audio recording devices such as microphones, and location tracking devices such as GPS locators. Secondary devices may be incorporated within a primary device such as a user or agent device 1202 or may be a separate device. Use of secondary devices may be requested by a user. A user may alternatively request for an agent to refrain from using a secondary device.

Furthermore, a banking engine 1205 may be in communication with the system via the processor 1200, the network 161, and the user or agent device 1202. The banking engine 1205 may be a third-party banking engine. The banking 1205 may be configured to facilitate a transfer of funds from a user to an agent. Fees may be collected by the system via the banking engine, as well as any third-party banking fees which may be required. The system may employ a plurality of cancellation and refund policies which may impact the amount of payment collected from a user or the amount of payment provided to an agent. The system may require a deposit to be paid prior to the completion of a security service.

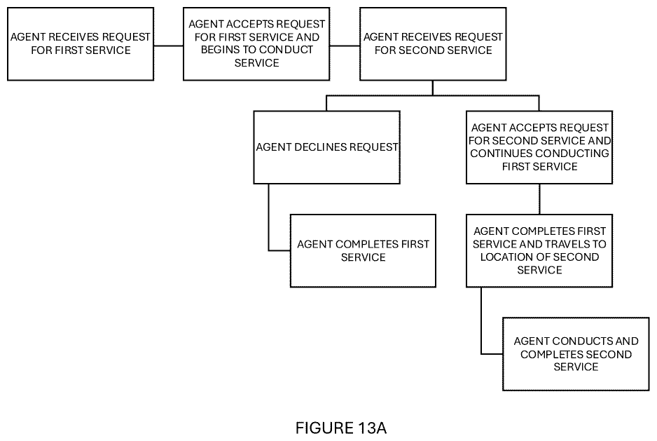

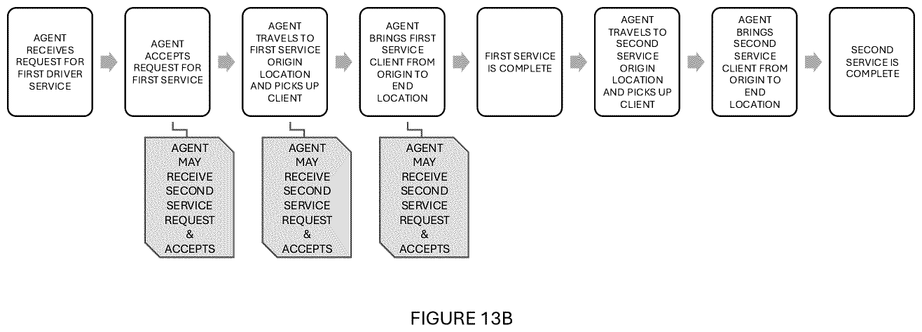

FIG. 13A is a diagram showing, in some embodiments, the receipt of a request for an agent while the agent is currently conducting another service request. The agent may receive a request for a first security service. The agent may accept the first service request and begin to conduct the service by traveling to the service location. The agent may receive the second service request while still conducting the first service request. The agent may accept or decline the second service request. If the agent accepts the request, the agent may continue conducting the first service request. Upon completion of the first service request, the agent may travel to the location of the second service request. The agent may conduct and complete the second service request. If the agent declines the second service request, the agent may complete only the first service request.

FIG. 13B is a diagram showing an example of an agent receiving a second driver service request while conducting a first driver service request. The agent may receive a request for a first driver service. The agent may (a) accept the request for the first service, (b) travel to the first service origin location and pick up client, and (c) bring the first service client from the origin to end location of the service. In any point from (a), (b), or (c), the agent may receive a second service request and accept the request while still conducting the first service to its completion. After the first service is complete, the agent may travel to the second service origin location and pick up the client. The agent may bring the second service client from the origin to end location of the service. The second service is then complete.

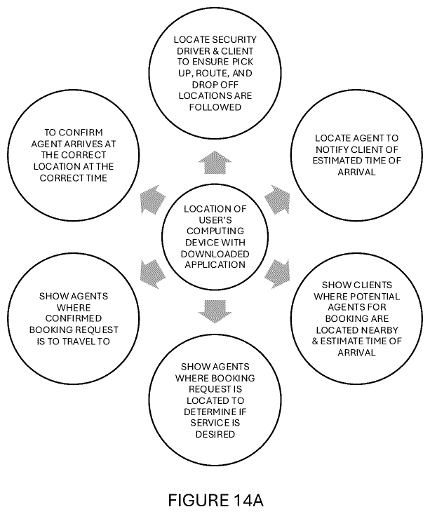

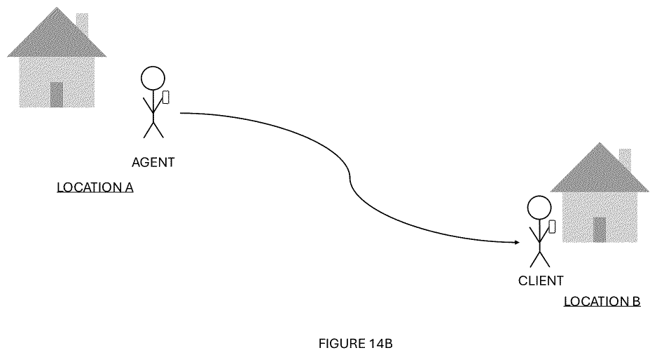

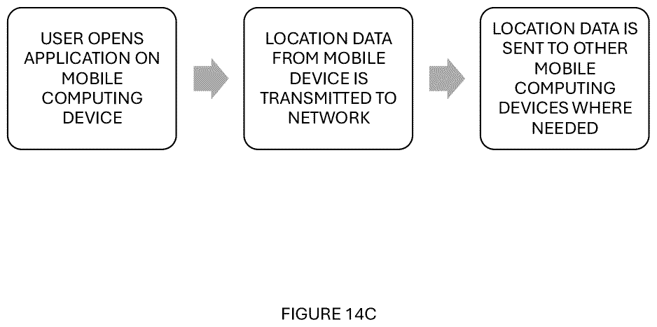

FIG. 14A demonstrates the multitude of uses of a user's location based on the location of a user's computing device with the downloaded application to track user location and ensure service production and completion. Upon downloading the application, users may be asked for their address and location. Both may be used to locate users. The location of clients may be used, for example, and not by means of limitation, for showing agents where a requested service is located to factor into their decision of whether to accept the request, or for communication with agents to ensure agents are arriving at the correct location to provide security services. The location of agents may, for example, and not by means of limitation, be used for communication with clients to inform clients of the geographical location of potential agents for booking purposes or to inform clients of where their security agent is relative to them to estimate time of arrival.

FIG. 14B illustrates one embodiment of the present invention in which an agent may, after receiving and accepting a request for service, travel with their mobile computing device to the location of the client with their mobile computing device. The agent may have their mobile computing device with them at Location A, which may be their residence, and can travel with their mobile computing device for location tracking purposes to Location B, where the client is requesting service with their mobile computing device.

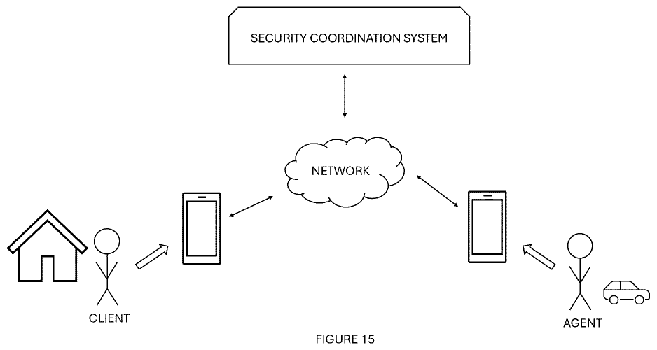

FIG. 14C demonstrates the process of the location data of a user's mobile computing device being sent to the network for transmission to other computing devices. The user may open their application on their mobile computing device. The location data from the mobile device may be transmitted to the network. The location data may be sent to other mobile computing devices where needed, for reasons including, but not limited to, those in FIG. 15A.

FIG. 15 is an illustration of one or more embodiments of the use of the application by client and agent to secure security services. In some embodiments, the client may be in need of security at their residence, requests it using their mobile computing device which sends the information through the network to the mobile computing device of the responding agent. The agent may receive the information then use their vehicle depending on the client's parameters to travel to the client and provide the security service. Information about the agent, including and not by means of limitation location and estimated time of arrival, may be communicated from the agent's mobile computing device through the network to the client's mobile computing device for the client to review. The information may be communicated to the security coordination system.

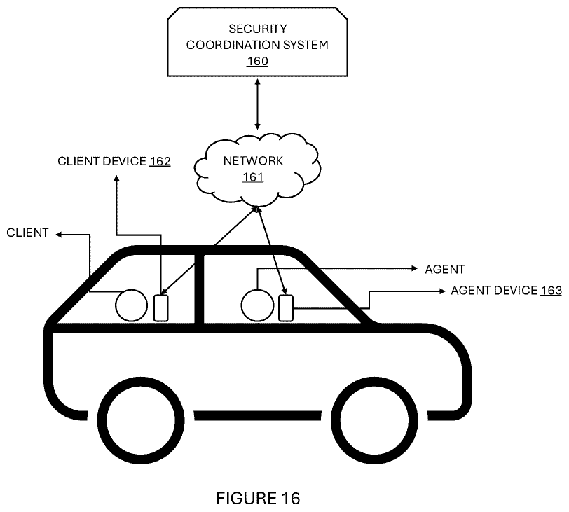

FIG. 16 demonstrates one embodiment of a security coordination system for client and agent. The embodiment may include a security coordination system 160 for security services to be scheduled and booking through. The system may interact with the network 161 to communicate to both client and agent devices the necessary information for the booked security service. In this embodiment, the client and agent are seen in a car which is one of the security options: driver. Both client and agent may have their personal computing device, 162 and 163, for direct communication with the network and indirect communication with the security coordination system for information on their booking including, but not limited to, estimated time of arrival, client and agent information, access to safety and customer service, map, route, and location.

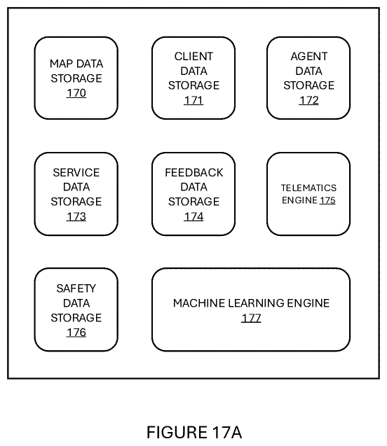

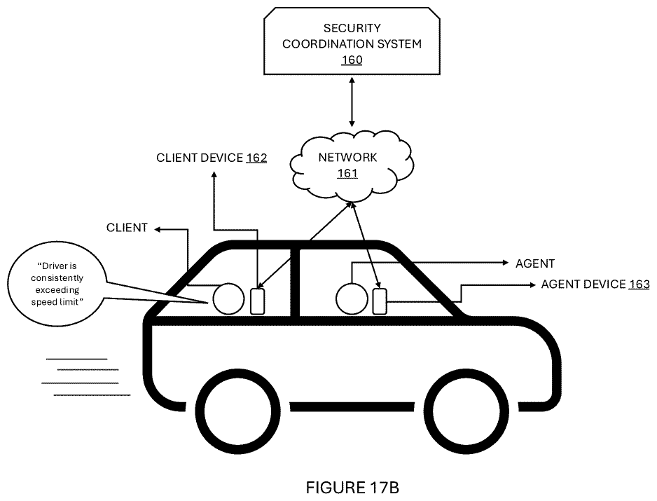

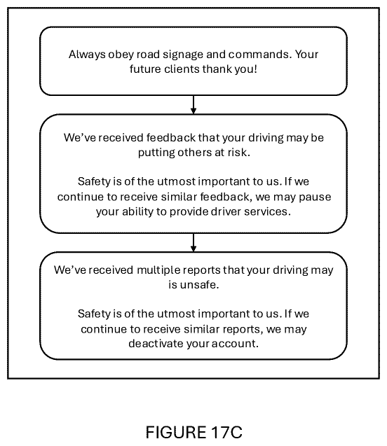

FIG. 17A illustrates a potential embodiment of the security coordination system. The security system 160 includes, but is not limited to, map data storage 170, client data storage 171, agent data storage 172, service data storage 173, feedback data storage 174, telematics engine 175, safety data storage 176, and machine learning engine 177. Conventional components including, but not limited to, network interfaces, additional security functions, load balancers, failover servers, and management and network operations consoles are not shown for the purpose of preventing obscuring the details of the system embodiment.

The map data storage 170 may store maps of geographic locations and regions in which the security coordination system 160 offers security services. The maps may contain information about roads within the geographic locations and regions. For example, and not by means of limitation, roads can include any route between two places that allows travel by foot, motor vehicle, bicycle, or other suitable form of travel. Examples of roads include streets, highways, freeways, trails, bridges, tunnels, toll roads, or crossings. Roads may be restricted to certain users or may be available for public use. The map data storage 170 may also include information about the roads. For example, and not my means of limitation, additional information may include speed limits, stop signs, traffic lights, crosswalks and sidewalks, intersections, turn restrictions, road signs, borders (i.e. country, state, county, province, city, and town), road material (e.g. dirt, cement, asphalt, concrete, gravel, cobblestone, etc.), and road directionality (e.g. one-way or two-way).

The client data storage 171 may store information about the client provided during set-up of the application on behalf of the client. This information may include, and not by means of limitation, name, email, phone number, photo, payment information, geographical location, types of services preferred, and past, current, and future bookings.

The agent data storage 172 may store information about the agent provided during set-up of the application on behalf of the client. This information may include, and not by means of limitation, name, email, phone number, photo, geographical location, types of services preferred, and past, current, and future bookings. Information about the agent's application, including but not limited to background check, security experience, languages spoken, driver's license, guard card, medical information, vehicle registration, weapon license, banking information, and additional security documents.

The service data storage 173 may store previous, current, and future booking details and information. This information may include, but is not limited to, client(s) and agent(s) names, type of service booked, service location, service payment and cost information, date and time of service, whether a vehicle or firearm was requested, and travel information including, but not limited to, map, duration, time of arrival, and time of departure.

The feedback data storage 174 may store user ratings and comments for services. User ratings include those left by and for clients and those by and for agents after a booking is completed which may factor into the star rating a user receives on their profile that other users can view. Comments may include those left by and for clients and by and for agents after a booking is completed.

The telematics engine 175 may collect and analyze data collected from computing devices used to book and during services. The telematics engine may receive data indirectly, for example and not by means of limitation, from the client device 162, the agent device 163, or another system via the network 161. The telematics engine 210 may store the telematics data in the service data storage 173 and may associate the telematics data with the appropriate security service. In one or more embodiments, the telematics engine 175 may process the telematics data to determine one or more parameters describing the security service. For example, and not by means of limitation, the telematics engine 175 may calculate the speed of the vehicle within which a driver security service is being carried out based on the telematics data generated by a client device 162 or agent device 163. The speed determined may be used to correspond to a first period of time during which the vehicle was traveling on a highway and a second period of time during which the vehicle was driving on local roads which may indicate that the driver security service is being carried out appropriately. As another example, the telematics engine 175 may determine the location of the client device 162 and agent device 163 based on speed or other factors to determine the location of the users and ensure the service is being carried out appropriately.

The safety data storage 176 may store user interactions including, but not limited to, live chat with customer service. The data may be stored for later analysis to improve safety functions within the application and ensure users are provided with the services they are requesting and booking.

The machine learning engine 177 may be used to facilitate the processes of any of the other processes within the security coordination system either listed or not listed above. Furthermore, the machine learning engine may be configured to analyze a request by a user in order to determine a best-fit selection of suggested security services. For example, and not by way of limitation, a user may submit a request for a security service with a plurality of preferences including, but not limited to, a certain rating threshold, a certain amount of experience providing a particular type of security service, a certain range of heights or weights, possession of certain permits such as conceal carry permits in accordance with state regulations, proximity to a user, and other preferences. The machine learning engine 177 may analyze the preferences as selected by a user and scan a system database to select a plurality of agent options that best fit the preferences provided by the user. The machine learning engine 177 may further be trained to anticipate a user's preferences by analyzing previous user requests and feedback provided by the user to the agents following a security service performance. Similarly, the machine learning engine 177 may be trained to anticipate the best-fit requests for an agent based on previous accepted requests by an agent and based on feedback provided by the agent to the users following a security service performance.

The machine learning engine 177 may further be configured to collect and analyze all relevant data pertaining to a potential agent in order to determine if a potential agent is qualified for security services. For example, and not by way of limitation, a potential agent may self-identify as having certain permits, certain background information, and certain physical characteristics. The machine learning engine 177 may collect the self-identified information and cross-reference the information with historical data including, but not limited to, state weapon permit registrations, state driving license and car registrations, previous background check reports including LiveScan reports, insurance documents and liability certificates, and other relevant data as accessible. The system may also require certain documents to be uploaded by a user or agent, including but not limited to, an image of a valid driver's license or passport, relevant permits and certifications, and other requested documentation to confirm user or agent identity or other characteristics.

FIG. 17B illustrates one embodiment of user feedback being used to impact safety and communication on the application. For example, and not by means of limitation, the machine learning engine 177 may be used to analyze comments and ratings left by users to notify specific users of actions they made need to take to remain in use of the application. For example, a client may be traveling with an agent during a driver security service, and the agent may be exceeding the total speed limit of the road being traveled. The client may utilize their personal computing device to communicate with the live chat function on their application and inform the system that their agent is consistently exceeding the speed limit. The machine learning engine 177, the telematics engine 175, and the feedback data storage 174 may work together to analyze the situation, analyze the client and agent profiles, and message the appropriate parties. For example, and not by means of limitation, the agent may be notified that they need to improve their driving or face no longer being able to provide driving services.

FIG. 17C illustrates an exemplary notification progression a user may receive based on user feedback and analysis from the machine learning engine. For example, and not by means of limitation, if an agent is reported to have committed a first driving offense, the agent may be notified that they need to obey road signage and commands. If the agent commits two or more driving offenses, the agent may be notified that they need to improve their driving or face a driving service suspension. If the agent continues to commit driving offenses, the agent may be notified that their account will be deactivated.

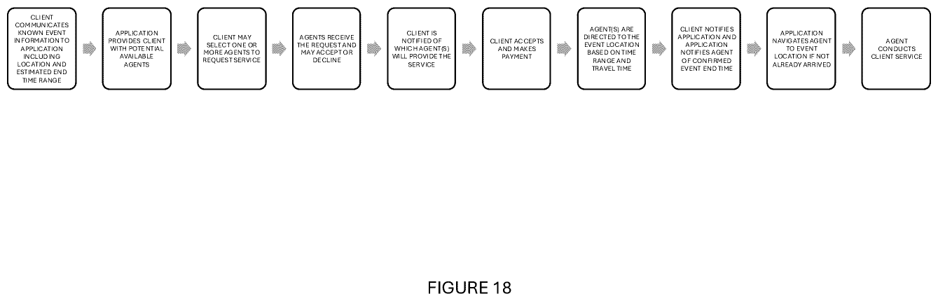

FIG. 18 illustrates one embodiment of a method for preemptively navigating agents to clients at an event initially without an end time. Clients may be at an event for which they desire an agent service after the event, such as, but limited to, agent accompaniment to their next location. However, clients may be unaware of the end time of their event. Event information may be communicated from the client to application including, but not limited to, an estimated range of time for the end of the event and the location of the event. The application may notify the client of agents who would be available during the provided time frame to reach the provided location. The client may select one or more agents to request service. Agent(s) may receive the request and may accept or decline. The client may be notified of which agent(s) will provide the service. The client may accept the booking and make the appropriate payment. The agent(s) may be directed to the event location based on the provided time range and travel time. The client may notify the application, and the application may notify the agent of the confirmed event end time. The application may navigate the agent(s) to the event location if the agent(s) have not yet arrived. The agent(s) may conduct the client's requested service.

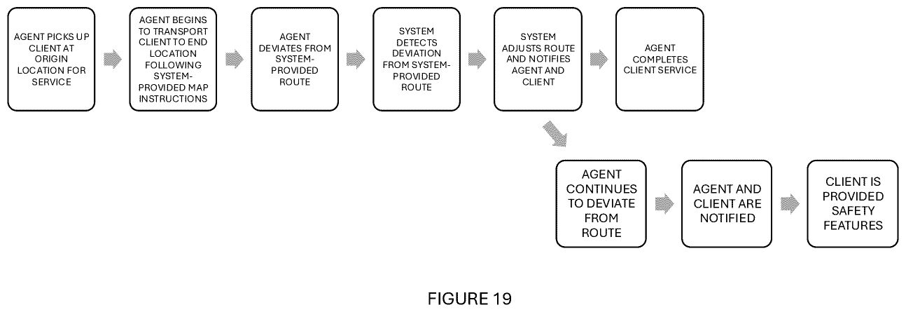

FIG. 19 is a flowchart indicating a potential embodiment of a system response to an agent not following the mapping directions for a client's requested security service. Users may be provided with maps on their application for a multitude of purposes including but not limited to travel directions for a service. For example, and not by means of limitation, a client may request a driver security service, and the agent may be provided directions through the application's map to arrive at the origin location and transport the client from the origin to the end location. For example, and not by means of limitation, if an agent deviates from the map travel directions given in the application, the application may process that deviation as it happens using the system 160, the telematics engine 175 and user personal devices, and machine learning engine 177, and the system may adjust the remaining directions to allow the client and agent to arrive at the end location. The system 160, telematics engine 175, and machine learning engine 177 may also assess how the changes in the service have impacted components including, but not limited to, estimated arrival time. As another example, and not by means of limitation, if the route continues to be improperly followed by the agent, both the agent and the client may be alerted through their personal mobile computing devices. In one or more embodiments, similar to FIGS. 17B and 17C, the agent may be notified in varying degrees, either during or after the service, that their service is not up to the application's standards and needs to be adjusted. The client may be notified of the adjustment in travel and provided additional safety measures including, but not limited to, the ability to communicate with live chat customer service and inform them of the situation.

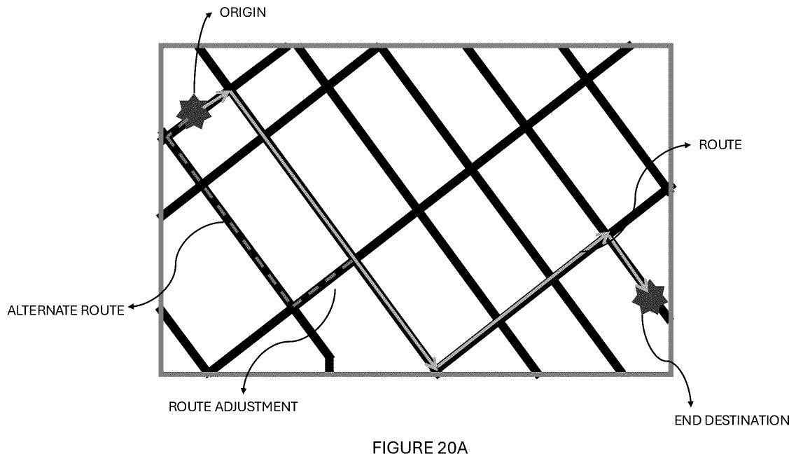

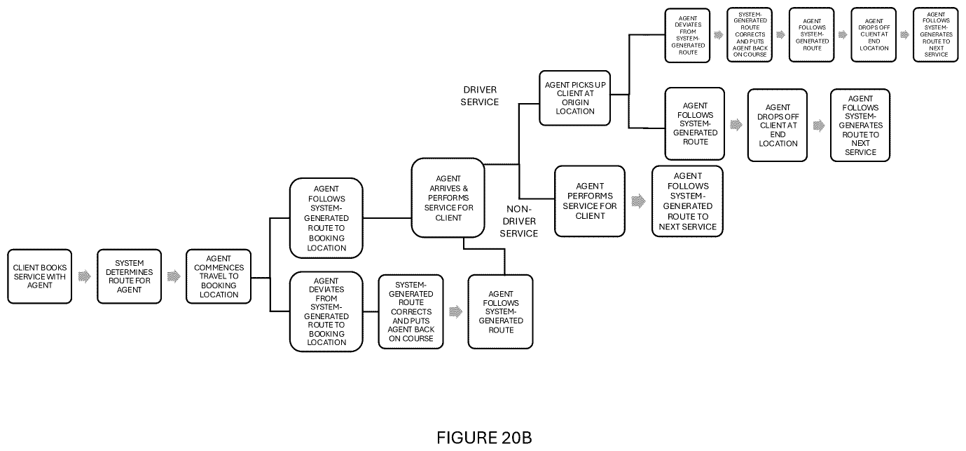

FIG. 20A is a diagram illustrating a map with the system-provided route and the alternative route an agent takes instead and how the course is corrected in one embodiment. For example, the route for a driving service between an origin and end destination may be generated by the system and communicated to users through the application. The agent may for example, and not by means of limitation, take a wrong turn and no longer be on the system-generated route. The system is able to detect this deviation, as seen in FIG. 19, and adjust the route to get the agent and client back on the route to reach the end destination.

FIG. 20B is a flowchart demonstrating a potential embodiment of the system's map system and route correction process. The client may book a service with an agent and the system may determine a route for the agent to travel to the location of the booking. The agent may commence travel to the booking location. The agent may then follow the system-generate route to the booking location. If the agent deviates from the system-generated route, the system is alerted and corrects the system-generated route to put the agent back on course. The agent may then follow the system-generated route. This embodiment may repeat for as many times as necessary. When the agent follows the system and arrives at the booking the location, the agent may perform the service the client booking. For example, and not by means of limitation, if the client booked a non-driver service, the agent may perform the service for the client at the location. Upon completion of the non-driver security service, the agent may travel to their next service following the system-generated route. If the client booked a driver security service, the agent may pick up the client at the origin location. The agent may then follow the system-generated route for the service. The agent may drop off the client at the end location and follow the system-generated route to their next service. If the agent deviates from the system-generated route, the system is alerted and corrects the system-generated route to put the agent back on course. The agent may follow the system-generated route. This embodiment may repeat for as many times as necessary. The agent may drop off the client at the end location and follow the system-generated route to their next service.

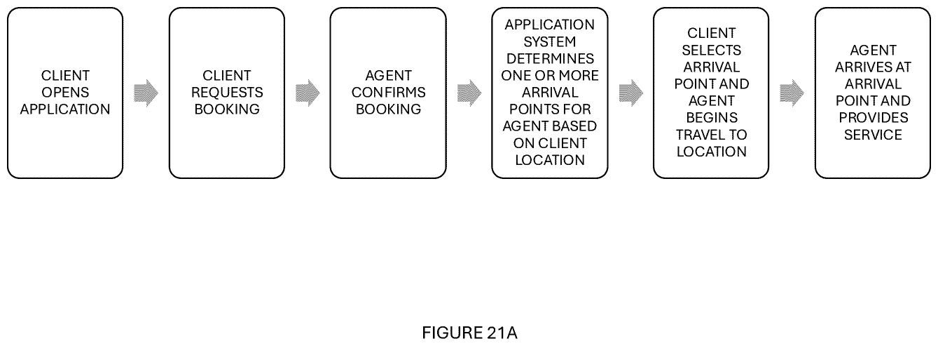

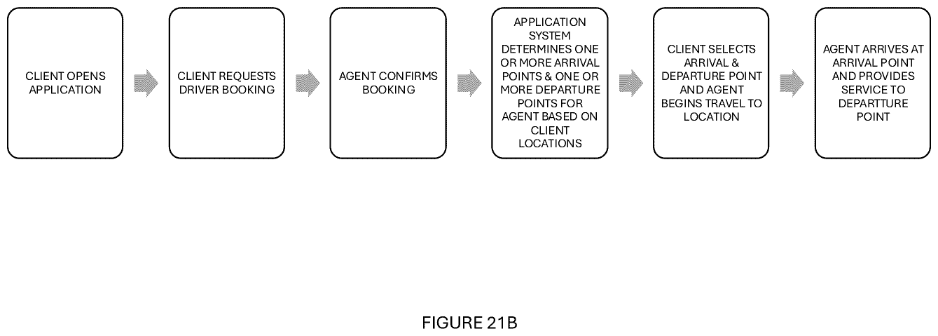

FIG. 21A is a flowchart demonstrating one embodiment of the system application's arrival point selection process. The client may open their application and request a security booking. The selected agent may confirm the booking. The application system then may use the location information provided by the client to determine one or more arrival points for the agent to be directed to. The client may select the arrival point of their preference, and the agent may be notified and begins travel to that location. The agent may arrive at the arrival point and provide the booked service.

FIG. 21B is a flowchart demonstrating one embodiment of the system application's arrival and departure point selection process for security driver services. The client may open their application and request a driver security booking. The selected agent may confirm the booking. The application system then may use the location information provided by the client to determine one or more arrival points and one or more departure points for the agent to be directed to. The client may select the arrival point and departure point of their preference, and the agent may be notified and begins travel to that arrival point. The agent may arrive at the arrival point and provide the booked service to the departure point.

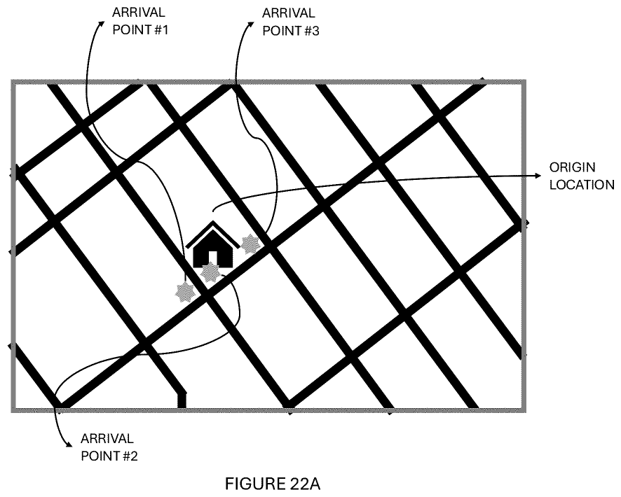

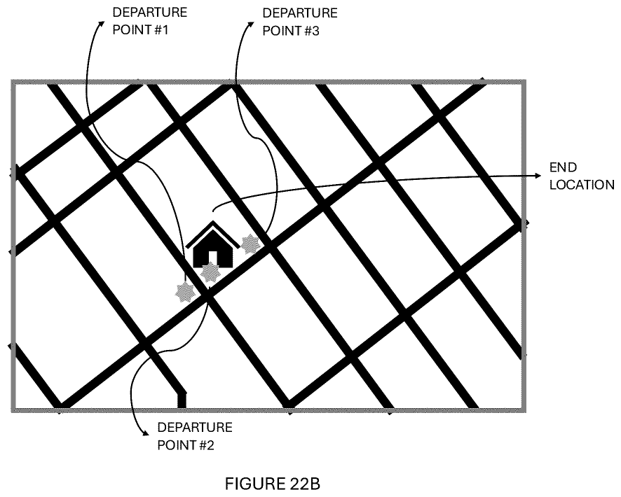

FIG. 22A illustrates a map with potential arrival points for an agent to be directed to during a security booking. The client may be offered a multitude of arrival points to select from around an origin location, and upon selection, the agent may be notified of the arrival point and directed to it at the beginning of the service.

FIG. 22B illustrates a map with potential departure points for an agent to be directed to during a driver security booking. The client may be offered a multitude of departure points to select from around an end location, and upon selection, the agent may be notified of the departure point and directed to it at the end of the driver service.

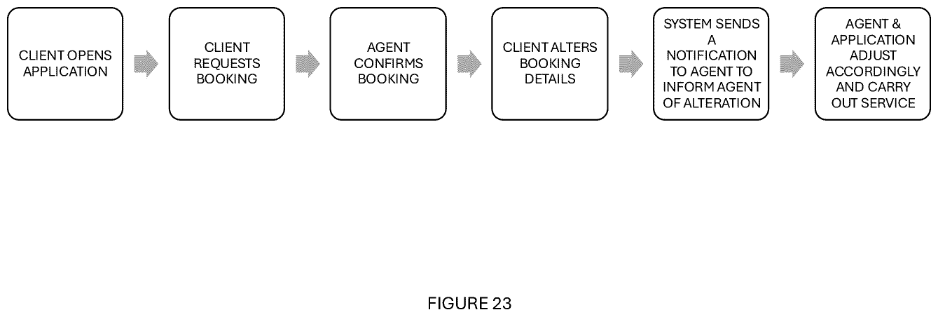

FIG. 23 is a flowchart showing one embodiment of a process for clients editing booking details and agents being notified. Clients may need to alter security booking details after a booking is confirmed, and agents may need to be notified of these alterations. The client may open their application, request a booking, and an agent may accept and confirm the booking. After the booking is confirmed, the client may edit details including, but not limited to, arrival location, departure location, time of service, whether a vehicle is needed, and whether a firearm is needed. The system may send a notification to the agent to inform the agent of the alteration(s) being made. The agent and the application adjust accordingly including, but not limited to, changing map routes, changing time of departure, and changing vehicle or firearm, and the agent may proceed to carry out the service.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A system for providing on-demand security services, said system comprising:
a network;
a user computing device in connection with said network;
at least one processor in connection with said network and in communication with said user computing device and a non-transitory computer-readable memory, wherein said non-transitory computer-readable memory is configured to store computer-executable instructions, which, when executed, cause said system to:
present, via said user computing device, a virtual interface;
receive, via said virtual interface, a request from said user for a security service;
generate a plurality of security service options based on said request;
receive, via said virtual interface, a selection from said user for a specific security service selected from said plurality of security service options;
transmit said request to a computing device associated with said selected security service;
confirm a booking of and payment for said selected security service;
transmit a location of said user to said selected security service; and
provide, to said user, an estimated time of arrival of said security service.

2. The system of claim 1, wherein said security service is a personal security guard.

3. The system of claim 1, wherein a machine learning engine completes a background check on said security service.

4. The system of claim 1, wherein said user selects a plurality of preferences regarding said security service prior to selection of said security service.

5. The system of claim 1, wherein said security service comprises providing secure transportation to a user from a first location to at least a second location.

6. The system of claim 1, wherein payment for a completed security service is collected from said user and facilitated to said security service.

7. The system of claim 1, wherein a user data history is stored in a cloud-based memory, wherein said user data history comprises user request history, user booking history, user feedback history, and user preference history, and wherein said user data history is analyzed via a machine learning engine in order to anticipate security service needs of said user.

8. A method for providing on-demand security services, said method comprising:
presenting a virtual interface via a user computing device in communication with at least one processor and a non-transitory computer-readable memory and in connection with a network;
receiving, via said virtual interface, a request from a user for a security service;
generating a plurality of security service options based on said request;
receiving, via said virtual interface, a selection from said user for a specific security service selected from said plurality of security service options;
transmitting said request to a computing device associated with said selected security service;
confirming a booking of and payment for said selected security service;
transmitting a location of said user to said selected security service;
providing, to said user, an estimated time of arrival of said security service; and
facilitating payment from said user to said security service via a banking engine.

9. The method of claim 8, wherein said security service is a personal security guard.

10. The method of claim 8, wherein a machine learning engine completes a background check on said security service.

11. The method of claim 8, wherein said user selects a plurality of preferences regarding said security service prior to selection of said security service.

12. The method of claim 8, wherein said security service comprises providing secure transportation to a user from a first location to at least a second location.

13. The method of claim 8, wherein said user is prompted to provide feedback following a use of said security service.

14. The method of claim 8, wherein a user data history is stored in a cloud-based memory, wherein said user data history comprises user request history, user booking history, user feedback history, and user preference history, and wherein said user data history is analyzed via a machine learning engine in order to anticipate security service needs of said user.

15. A system for providing on-demand security services, said system comprising:
a network;
a user computing device in connection with said network;
at least one processor in communication with said user computing device and a non-transitory computer-readable memory, wherein said non-transitory computer-readable memory is configured to store computer-executable instructions, which, when executed, cause said system to:
present, via said user computing device, a virtual interface;
receive, via said virtual interface, a request from said user for a security service, wherein said request further comprises a selection of a plurality of preferences of said user;
analyze, via a machine learning engine, all potential security service options associated with said system to determine a suggestion of select potential security service options based on said request and on a proximity to said user;
present said suggestion of select potential security service options to said user via said virtual interface;
receive, via said virtual interface, a selection from said user for a specific security service selected from said suggestion of select potential security service options;
transmit said request to a computing device associated with said selected security service;
confirm a booking of and payment for said selected security service;
transmit a location of said user to said selected security service;
provide, to said user, an estimated time of arrival of said security service;
facilitate, via a banking engine, payment from said user to said security service;
prompt, via said virtual interface, said user to provide feedback for said security service following completion of said security service; and
prompt, via a second virtual interface, said security service to provide feedback for said user following completion of said security service for said user.

16. The system of claim 15, wherein said security service is a personal security guard.

17. The system of claim 15, wherein said security service comprises providing secure transportation to a user from a first location to at least a second location.

18. The system of claim 15, wherein said security service is performed at a single location.

19. The system of claim 15, wherein an estimated duration of said security service is provided to said requested security service prior to booking.

20. The system of claim 15, wherein a plurality of security services are booked for a single event.
